(19) United States
(12) Patent Application Publication
(10) Pub. No.: US 2025/0332697 A1
(43) Pub. Date: Oct. 30, 2025

(54) POWER TOOL WITH EXTERNALLY ADJUSTABLE CLUTCH MECHANISM AND CLUTCH SENSOR THEREFOR

(71) Applicant: MILWAUKEE ELECTRIC TOOL CORPORATION, Brookfield, WI (US)

(72) Inventors: Matthew G. Morris, Milwaukee, WI (US); Brendan Anderson, Brookfield, WI (US); Nathan P. Sievers, West Allis, WI (US); Hal Crossno, Brookfield, WI (US); Braden Roberts, Brookfield, WI (US); Scott R. Fischer, Menomonee Falls, WI (US); Alejandro Vegas, Menomonee Falls, WI (US)

(21) Appl. No.: 19/189,927

(22) Filed: Apr. 25, 2025

Related U.S. Application Data
(60) Provisional application No. 63/639,433, filed on Apr. 26, 2024.
(60) Provisional application No. 63/716,558, filed on Nov. 5, 2024.

(51) Int. Cl. B25B 23/147; B25B 23/14

(52) U.S. Cl. CPC B25B 23/147; B25B 23/141

(57) ABSTRACT

A nutrunner includes a housing, a motor within the housing and including an output shaft rotatable about a first axis, a head extending from the housing and including an output drive that is rotatable about a second axis, and a transmission configured to transfer rotation from the output shaft to the output drive, the transmission including a drive plate that is rotatable about the first axis with respect to the housing. The nutrunner also includes a clutch mechanism having a driven plate coupled with the drive plate via a plurality of output bearings configured such that, when a torque applied to the driven plate is greater than or equal to a torque threshold, the output bearings slip and torque transfer from the drive plate to the driven plate is interrupted. A clutch slip sensor is configured to detect an axial position of the driven plate and includes an inductive sensor.

### CROSS-REFERENCE TO RELATED APPLICATIONS

This application claims priority to U.S. Provisional Patent Application No. 63/716,558, filed Nov. 5, 2024, and to U.S. Provisional Patent Application No. 63/639,433, filed Apr. 26, 2024, the entire contents of each of which is incorporated herein by reference.

### TECHNICAL FIELD

The present disclosure relates to power tools, and more particularly to powered nutrunner tools.

### BACKGROUND

A nutrunner is a fastening tool that may be particularly suited for repetitive fastening tasks, such as in a manufacturing or assembly environment. In such applications, it is often desirable to tighten a fastener to a consistent and repeatable torque setting.

### SUMMARY

The present disclosure provides, in some aspects, a power tool, and more particularly a nutrunner tool, including a housing, a motor with an output shaft arranged along a first axis, a head including an output drive that is rotatable about a second axis perpendicular to the first axis, and a transmission configured to transfer torque and rotation from the output shaft to the output drive. The nutrunner also includes a clutch mechanism including two opposing gears and a recess in the housing configured to receive an adjuster. Rotation of the adjuster adjusts a torque threshold at which the clutch mechanism slips to limit torque transfer to the output drive.

In some aspects, the techniques described herein relate to a nutrunner including: a housing; a motor disposed within the housing and including an output shaft rotatable about a first axis; a head extending from the housing, the head including an output drive that is rotatable about a second axis; a transmission configured to transfer rotation from the output shaft to the output drive, the transmission including a drive plate that is rotatable about the first axis with respect to the housing; a clutch mechanism including: a driven plate coupled with the drive plate via a plurality of output bearings, a spindle operatively coupled with the output shaft of the motor, the spindle having a first end coupled for co-rotation with the driven plate, a first gear coupled for co-rotation with a second end of the spindle, and a spring positioned around the spindle and between the first gear and the driven plate, the spring configured to bias the plurality of output bearings into engagement with the drive plate, wherein when a torque applied to the driven plate is greater than or equal to a torque threshold, the output bearings slip and torque transfer from the drive plate to the driven plate is interrupted; and a clutch slip sensor configured to detect an axial position of the driven plate, wherein the clutch slip sensor includes an inductive sensor.

In some aspects, the techniques described herein relate to a nutrunner, further including a slot in the housing, the slot extending along first axis.

In some aspects, the techniques described herein relate to a nutrunner, wherein the slot is configured to allow an adjuster to be inserted into the nutrunner to facilitate adjustment of the clutch mechanism to different torque settings.

In some aspects, the techniques described herein relate to a nutrunner, further including a second gear coupled opposing the first gear.

In some aspects, the techniques described herein relate to a nutrunner, wherein the first gear includes a plurality of first gear teeth and the second gear includes a plurality of second gear teeth.

In some aspects, the techniques described herein relate to a nutrunner, wherein the first gear teeth and the second gear teeth create a wave pattern between the gears, the wave pattern corresponding to an adjuster such that the adjuster may be inserted between the first gear teeth and the second gear teeth.

In some aspects, the techniques described herein relate to a nutrunner, wherein in response to rotation of the adjuster, the first gear moves axially along the spindle, thereby varying a pre-load on the spring.

In some aspects, the techniques described herein relate to a nutrunner, further including a controller in communication with the clutch slip sensor, the controller configured to turn off the motor in response to feedback from the clutch slip sensor indicating that the clutch mechanism has slipped.

In some aspects, the techniques described herein relate to a nutrunner, wherein the clutch slip sensor is disposed within a recess within the housing such that an internal portion of the housing supports the clutch slip sensor.

In some aspects, the techniques described herein relate to a nutrunner, wherein the recess extends along a third axis parallel to the first axis.

In some aspects, the techniques described herein relate to a nutrunner, wherein the housing includes a battery receptacle configured to receive a battery to provide power to the motor, and wherein the housing includes a grip portion extending between the battery receptacle and a motor housing portion of the housing in which the motor is supported.

In some aspects, the techniques described herein relate to a nutrunner, further including a first printed circuit board assembly located in the housing between the motor and the battery receptacle, the first printed circuit board assembly including a plurality of switches for providing power to the motor.

In some aspects, the techniques described herein relate to a nutrunner, further including a second printed circuit board assembly including a Hall effect sensor.

In some aspects, the techniques described herein relate to a nutrunner, wherein the second printed circuit board assembly is located between the motor and the first printed circuit board assembly.

In some aspects, the techniques described herein relate to a nutrunner, further including a third printed circuit board assembly including the clutch slip sensor.

In some aspects, the techniques described herein relate to a nutrunner, wherein the clutch slip sensor includes an induction coil configured to provide signals to the inductive sensor.

In some aspects, the techniques described herein relate to a nutrunner, wherein the third printed circuit board assembly is supported by a carrier, and wherein the carrier and the third printed circuit board assembly are sandwiched between the head and the housing.

In some aspects, the techniques described herein relate to a nutrunner, wherein the third printed circuit board assembly is partially received within a first recess formed in the head and a second recess formed in the housing, wherein a first opening extends from the second recess parallel to the first axis, wherein a second opening extends from the second recess in a radial direction perpendicular to the first axis, and wherein the second recess is aligned with the induction coil to expose the induction coil directly to the driven plate.

In some aspects, the techniques described herein relate to a nutrunner including: a housing including a battery receptacle configured to receive a battery, a motor housing portion, and a grip portion extending between the battery receptacle and the motor housing portion; a motor supported within the motor housing portion, the motor including an output shaft rotatable about a first axis; a head extending from the housing, the head including an output drive rotatable about a second axis; a first printed circuit board assembly located in the housing between the motor and the battery receptacle, the first printed circuit board assembly including a plurality of switches for providing power to the motor; a second printed circuit board assembly including a Hall effect sensor; a clutch mechanism operatively coupled between the output shaft of the motor and the output drive such that the clutch mechanism is configured to slip to interrupt torque transmission from the output shaft to the output drive at a selected torque threshold; and a third printed circuit board assembly including a clutch slip sensor configured to detect if the clutch mechanism slips.

In some aspects, the techniques described herein relate to a nutrunner, wherein the second printed circuit board assembly is located between the motor and the first printed circuit board assembly.

In some aspects, the techniques described herein relate to a nutrunner, wherein the third printed circuit board assembly is partially received within a first recess formed in the head and a second recess formed in the housing, wherein a first opening extends from the second recess parallel to the first axis, wherein a second opening extends from the second recess in a radial direction perpendicular to the first axis, wherein the third printed circuit board assembly includes an induction coil, and wherein the second recess is aligned with the induction coil to expose the induction coil directly to an axially-movable portion of the clutch mechanism.

In some aspects, the techniques described herein relate to a nutrunner, wherein the second axis is perpendicular to the first axis.

In some aspects, the techniques described herein relate to a nutrunner including: a housing including a battery receptacle configured to receive a battery, a motor housing portion, and a grip portion extending between the battery receptacle and the motor housing portion; a motor supported within the motor housing portion, the motor including an output shaft rotatable about a first axis; a head extending from the housing, the head including an output drive rotatable about a second axis perpendicular to the first axis; a clutch mechanism operatively coupled between the output shaft of the motor and the output drive such that the clutch mechanism is configured to slip to interrupt torque transmission from the output shaft to the output drive at a selected torque threshold; and a printed circuit board assembly including a clutch slip sensor configured to detect if the clutch mechanism slips, wherein the printed circuit board assembly is partially received within a first recess formed in the head and a second recess formed in the housing, wherein a first opening extends from the second recess parallel to the first axis, wherein a second opening extends from the second recess in a radial direction perpendicular to the first axis, wherein the printed circuit board assembly includes an induction coil, and wherein the second recess is aligned with the induction coil to expose the induction coil directly to an axially-movable portion of the clutch mechanism.

Other aspects of the disclosure will become apparent by consideration of the detailed description and accompanying drawings.

### BRIEF DESCRIPTION OF THE DRAWINGS

FIG. 1 is a perspective view of a nutrunner according to an embodiment of the present disclosure.

FIG. 2 is a section view of the nutrunner of FIG. 1.

FIG. 3 is a side view of the nutrunner of FIG. 1 illustrating a clutch mechanism.

FIG. 4A is a first isolated perspective view of a drive plate of the clutch mechanism of FIG. 3.

FIG. 4B is a second isolated perspective view of the drive plate of the clutch mechanism of FIG. 3.

FIG. 5A is a first isolated perspective view of a driven plate of the clutch mechanism of FIG. 3.

FIG. 5B is a second isolated perspective view of the driven plate of the clutch mechanism of FIG. 3.

FIG. 6A is a perspective view of the clutch mechanism of FIG. 3 illustrating a printed circuit board assembly, according to a first embodiment.

FIG. 6B is a cross-sectional view illustrating the printed circuit board assembly of FIG. 6A within a housing of the nutrunner of FIG. 1.

FIG. 6C is an exploded view of the print circuit board assembly and a portion of the housing of FIG. 6B.

FIG. 7 is a perspective view of the clutch mechanism of FIG. 3 illustrating an alternate printed circuit board assembly, according to a second embodiment.

FIG. 8A is side view of the clutch mechanism of FIG. 3 illustrating an adjustment mechanism.

FIG. 8B is a section view of the clutch mechanism and adjustment mechanism of FIG. 8A.

FIG. 9 is a perspective view of a nutrunner according to another embodiment of the present disclosure.

FIG. 10 is a cross-sectional view of a portion of a nutrunner according to another embodiment of the present disclosure.

Before any embodiments of the disclosure are explained in detail, it is to be understood that the disclosure is not limited in its application to the details of embodiment and the arrangement of components set forth in the following description or illustrated in the following drawings. The disclosure is capable of other embodiments and of being practiced or of being carried out in various ways.

### DETAILED DESCRIPTION

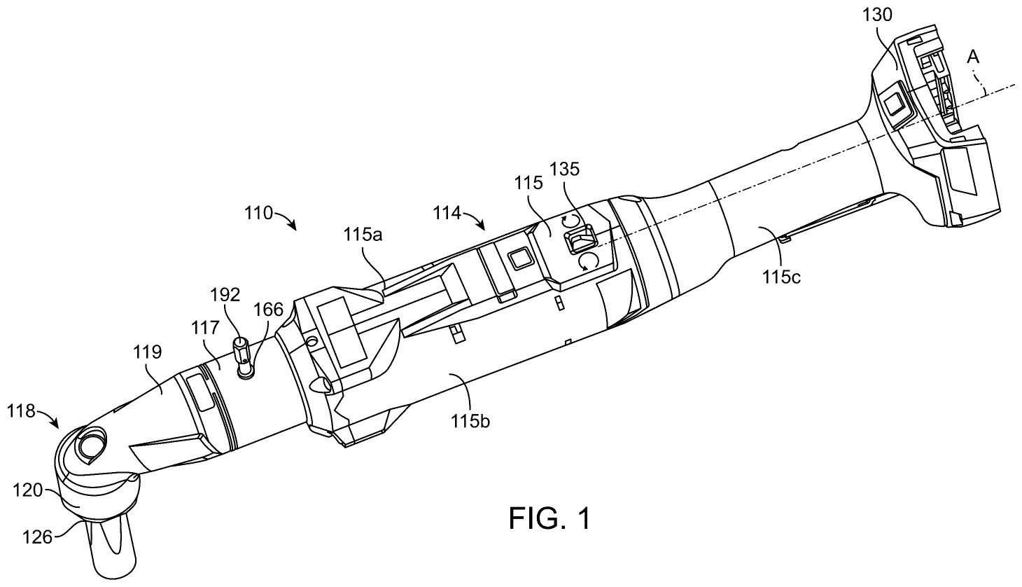

FIG. 1 illustrates an embodiment of a power tool in the form of a powered nutrunner 110. The nutrunner 110 includes a housing 114 having a handle housing 115 and a head 118 coupled to the handle housing 115. The illustrated handle housing 115 comprises two cooperating clamshell halves 115a, 115b, which may be made, for example, from a molded plastic material. The handle housing 115 also includes a grip portion 115c configured to be grasped by a user during operation of the nutrunner 110. The grip portion 115c may be covered by an elastomeric overmold in some embodiments.

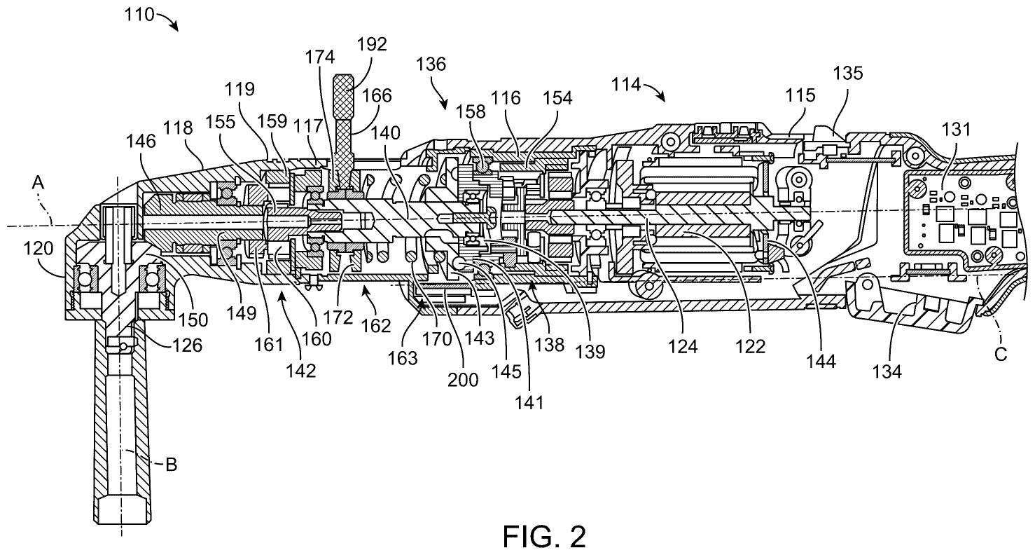

Referring to FIG. 2, a first gearcase 116 is coupled to and received within the handle housing 115. The head 118 includes a clutch housing portion 117 coupled to the handle housing 115, a second gearcase 119 extending from the clutch housing portion 117, and an output portion 120 extending from the second gearcase 119. In the illustrated embodiment, the clutch housing portion 117, the second gearcase 119, and the output portion 120 are all integrally formed together as a single piece, defining the head 118. The illustrated head 118 is made of metal and coupled to the handle housing 115 by a plurality of fasteners. In other embodiments, the head 118 may comprise multiple pieces coupled together, may be made from other materials, and/or may be coupled to the handle housing 115 in other ways.

The housing 114 of the nutrunner 110 defines an elongated, in-line configuration, with the handle housing 115, first gearcase 116, clutch housing portion 117, and second gearcase 119 arranged in series along a longitudinal axis or first axis A. In the illustrated embodiment, the output portion 120 extends along a second axis B perpendicular to the first axis A.

With continued reference to FIG. 2, a motor 122 is supported within a motor housing portion of the handle housing 115 and has a rotor with an output shaft 124 rotatable about the first axis A. The motor 122 is configured to provide torque to an output drive 126 rotatably supported by output portion 120 of the head 118 for rotation about the second axis B. The illustrated motor 122 is a brushless DC motor. In some embodiments, the motor 122 may be a surface permanent magnet (SPM) motor including a stator, a rotor, and permanent magnets affixed to or embedded in an exterior surface of the rotor. In other embodiments, the motor 122 may be an outer rotor motor, having a rotor that surrounds and rotates about the stator. In other embodiments, other types of motors (including pneumatic motors, for example) may be used.

The illustrated output drive 126 is configured to receive a tool bit (e.g., a socket), which may in turn cooperate with and perform work on a workpiece (e.g., a fastener). In some embodiments, the output drive 126 includes a square drive head, with a nominal size of ⅜-inch, ½-inch, ¾-inch, 1-inch, or any other desired size. In other embodiments, the output drive 126 may include a splined drive head, a hexagonal recess, or any other suitable geometry for receiving a tool bit.

In the illustrated embodiment, the nutrunner 110 includes a battery receptacle 130 formed in the housing 114, and more particularly at a rear end of the handle housing 115 opposite the head 118 (FIG. 1). The battery receptacle 130 is configured to receive a battery pack (e.g., a rechargeable power tool battery pack; not shown). The battery pack may have a nominal output voltage of 18-Volts in some embodiments. The battery receptacle 130 electrically connects the battery pack to the motor 122 via suitable electrical and electronic components, such as a PCBA 131 containing MOSFETs, IGBTs, or the like. The illustrated PCBA 131 (a first PCBA) is located in the handle housing 115, between the motor 122 and the battery receptacle 130. However, the location of the PCBA 131 may vary in other embodiments. A second PCBA 144 is coupled to the motor 122 and includes one or more Hall effect sensors for monitoring rotation of the rotor. The second PCBA 144 may provide signals to the first PCBA 131 used in controlling operation of the motor 122. In the illustrated embodiment, the second PCBA 144 is located between the motor 122 and the first PCBA 131; however, the second PCBA 144 may be located elsewhere in other embodiments.

In the illustrated embodiment, the battery receptacle 130 is oriented such that the battery pack is insertable and removable from the battery receptacle 130 in a direction that is perpendicular with respect to the first axis A (and parallel to the second axis B). In other embodiments, the battery receptacle 130 may be oriented such that the battery pack is insertable and removable in a direction parallel to the first axis A or obliquely oriented relative to the first axis A.

Referring to FIG. 2, in the illustrated embodiment, the nutrunner 110 includes an actuator 134 for controlling operation of the nutrunner 110 (e.g., to energize/de-energize the motor 122 and, in some embodiments, control an operating speed of the motor 122). In the illustrated embodiment, the actuator 134 is a trigger that is pivotable between an “on position,” in which the motor 122 is energized, and an “off position,” in which the motor 122 is de-energized. The actuator 134 provides an input to a suitable switch, such as an on/off switch, a pressure sensor, a variable speed switch, or the like. In the illustrated embodiment, a forward/reverse actuator 135, provided on a side of the handle housing 115 opposite the actuator 134, allows a user to select an operating direction of the motor 122. The illustrated actuator 134 and forward/reverse actuator 135 are each positioned between the battery receptacle 130 and the head 118 in a direction along the first axis A.

Referring to FIG. 2, the output drive 126 is operably coupled to the output shaft of the motor 122 via a gear assembly or transmission 136. The transmission 136 includes a first transmission portion 138 supported within the first gearcase 116. The first transmission portion 138 operably couples the output shaft 124 of the motor 122 to a spindle 140. The illustrated transmission 136 also includes a second transmission portion 142 supported within the second gearcase 119. The second transmission portion 142 operably couples the spindle 140 to a first bevel gear 146 via a bevel gear shaft 149. The first bevel gear 146 drives a second bevel gear 150 coupled to (and, in the illustrated embodiment, integrally formed with) the output drive 126. Either or both the first transmission portion 138 and the second transmission portion 142 may be planetary transmissions.

In the illustrated embodiment, the first transmission portion 138 is a two-stage planetary transmission including a last stage carrier 139 defining an output of the first transmission portion 138. The last stage carrier 139 is coupled for co-rotation with a drive plate 141, which in turn is coupled for co-rotation with a driven plate 143 via a plurality of ball bearings 145. The driven plate 143 is coupled for co-rotation with the spindle 140 (e.g., via a spline fit or other suitable torque-transferring connection). In other embodiments, the first transmission portion 138 may consist of a different number of stages. In the illustrated embodiment, the second transmission portion 142 is a single-stage planetary transmission. In other embodiments, the second transmission portion 142 may consist of a different number of stages or may be omitted in yet other embodiments. In some embodiments, other types of transmissions or gear reductions may be included as the first transmission portion 138 and/or second transmission portion 142.

The first transmission portion 138 includes a ring gear 154 that is supported within the first gearcase 116 concentric with the first axis A. The illustrated ring gear 154 is common to both stages of the first transmission portion 138. That is, two sets of planet gears are meshed with the teeth of the ring gear 154 to rotate about the inner periphery of the ring gear 154. A radial bearing 158 (which may be a bushing, roller bearing, or the like) is positioned within the first gearcase in front of the ring gear 154 to rotatably support the last stage carrier 139.

With continued reference to FIG. 2, the second transmission portion 142 includes a ring gear 159 fixed within the second gearcase 119, a plurality of planet gears 160, and a carrier 161. The carrier 161 is coupled for co-rotation with a shaft portion of the first bevel gear 146 (e.g., via a spline fit or other suitable torque-transferring connection). The planet gears 160 are operably driven by the spindle 140 (e.g., the planet gears 160 are driven by a sun gear 155 and the sun gear 155 is meshed with the first bevel gear 146 which is driven by the spindle 140) to advance around an inner periphery of the ring gear 159, thereby rotating the carrier 161 and the second bevel gear 150.

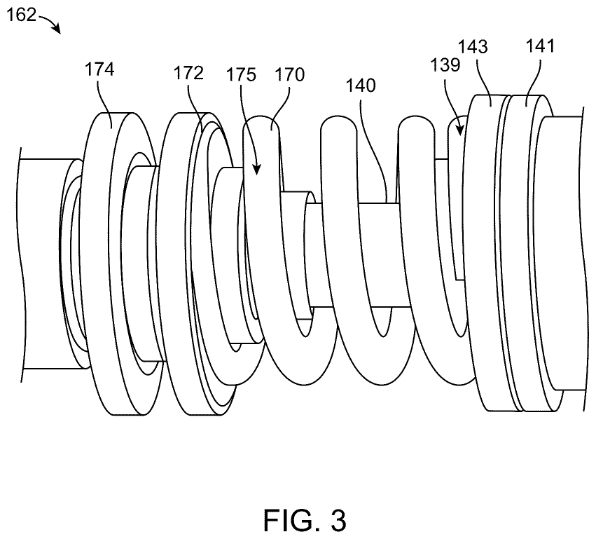

Referring to FIGS. 3-6B, the illustrated nutrunner 110 includes a clutch mechanism 162 operably coupled between the output shaft 124 of the motor 122 and the output drive 126 to selectively limit torque transmission to the output drive 126 above a chosen torque threshold. More specifically, in the illustrated embodiment, the clutch mechanism 162 is coupled between the first transmission portion 138 and the second transmission portion 142; however, in other embodiments, the clutch mechanism 162 may be coupled between the output shaft 124 and the first transmission portion 138 or between the output drive 126 and the second transmission portion 142. The clutch mechanism 162 allows a user to limit torque output of the nutrunner 110 to a desired torque setting. In the illustrated embodiment, the clutch mechanism 162 is operable to limit the torque transfer from the first transmission portion 138 to the second transmission portion 142 to a first set torque limit in a first rotational direction (e.g., a tightening direction), and to limit the torque transfer the first transmission portion 138 to the second transmission portion 142 to a second set torque limit (e.g., greater than the first set torque limit) or to not limit the torque transfer from the first transmission portion 138 to the second transmission portion 142 in a second, opposite rotational direction (e.g., a loosening direction). In this way, the clutch mechanism 162 may prevent over-tightening of a fastener but may allow a greater torque output of the nutrunner 110 to be available to loosen an over-tightened fastener or break free a stuck fastener.

The clutch mechanism 162 includes a biasing member or spring 170, the drive plate 141, the driven plate 143, a first gear 172, and a second gear 174. The clutch mechanism 162 aids the user in assembling delicate joint screws or screws with a specified torque rating, for example. In the illustrated embodiment, the clutch housing portion 117 includes an aperture 166 configured to allow an adjuster 192 to be inserted into the nutrunner 110 to facilitate adjustment of the clutch mechanism 162 to different torque settings via the exterior adjuster 192 (e.g., a screwdriver or hex wrench). The aperture 166 is substantially circular in shape and is disposed between the first gearcase 116 and the second gearcase 119.

The spring 170 is disposed within the clutch housing portion 117. A first end of the spring 170 engages the driven plate 143 (either directly or through a washer positioned between the first end of the spring 170 and the driven plate 143). A second end of the spring 170 engages the first gear 172. In the present embodiment, the spring 170 engages with the first gear 172 directly, however, in other embodiments, the spring 170 may engage the first gear 172 through a washer positioned between the second end of the spring 170 and the first gear 172). The spring 170 is configured to bias the driven plate 143 toward the drive plate 141.

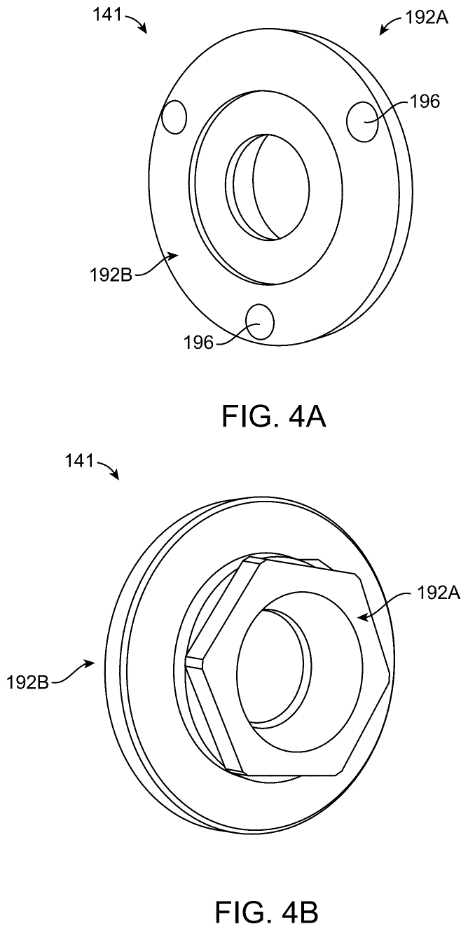

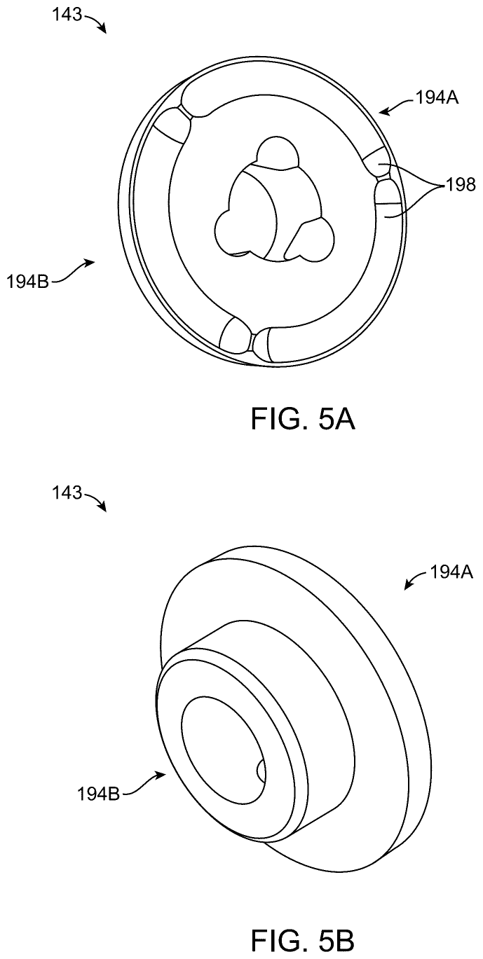

Referring to FIGS. 4A-5B, the drive plate 141 and the driven plate 143 each include grooves and recesses configured to receive the ball bearings 145. The drive plate 141 includes a first drive side 192A and a second drive side 192B. The second drive side 192B includes a plurality of recesses 196. Each recess 196 is configured to receive an output bearing 145. In the present embodiment, the drive plate 141 includes three recesses 196. Accordingly, three ball bearings 145 are disposed between the drive plate 141 and the driven plate 143. In alternate embodiments, any number of bearings may be disposed between the drive plate 141 and the driven plate 143. Similarly, the driven plate 143 includes a first driven side 194A and a second driven side 194B. The first driven side 194A is in contact with the second drive side 192B of the drive plate 141. The first driven side 194A of the driven plate 143 includes a plurality of arc-shaped grooves 198. In the present embodiment, each groove 198 is configured to receive one of the three bearings 145. Accordingly, the driven plate 143 includes three grooves 198. The grooves 198 correspond to the recesses 196 such that the three bearings 145 are held between the drive plate 141 and the driven plate.

In response to the spring 170 biasing the driven plate 143 toward the drive plate 141, the ball bearings 145 are biased into the grooves 198 and recesses 196 formed in the plates 141, 143. At torque levels below the set torque limit, the drive plate 141 transmits torque to the driven plate 143 and the spindle 140 through the ball bearings 145 sandwiched between the drive plate 141 and the driven plate 143. In response to the torque exceeding the torque limit, the ball bearings 145 slip out of the recesses and torque transfer from the drive plate 141 to the driven plate 143 is interrupted.

With reference back to FIG. 2, a third printed circuit board assembly (PCBA) 200 is arranged within the housing 114 below the clutch mechanism 162. More specifically, the handle housing 115 and the head 118 collectively define a cavity 163 that accommodates the third PCBA 200. The cavity 163 is disposed below the spindle 140 and the driven plate 143 and is spaced from the driven plate 143 such that there is a gap therebetween. As such, the third PCBA 200 avoids contact with the clutch mechanism 162. In the present embodiment, the third PCBA 200 extends along an axis C which runs parallel to axis A.

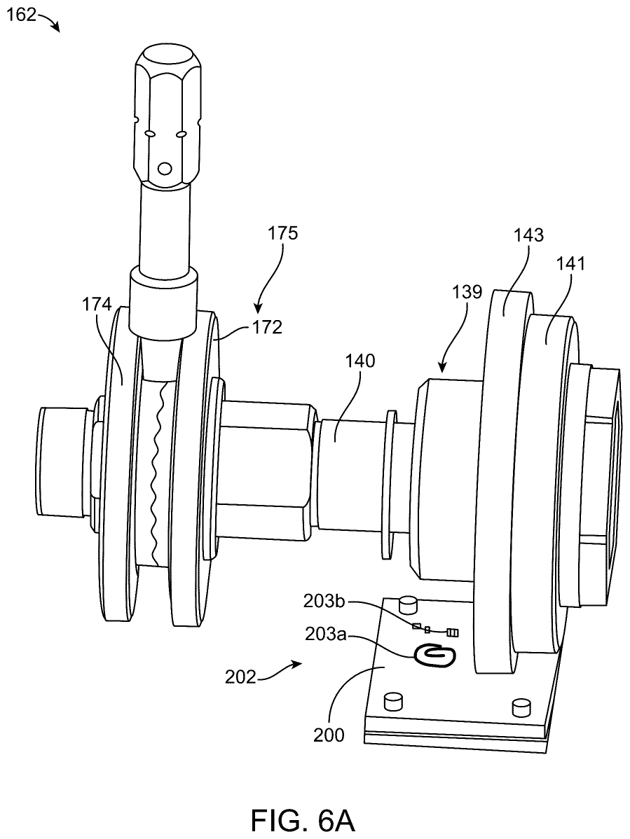

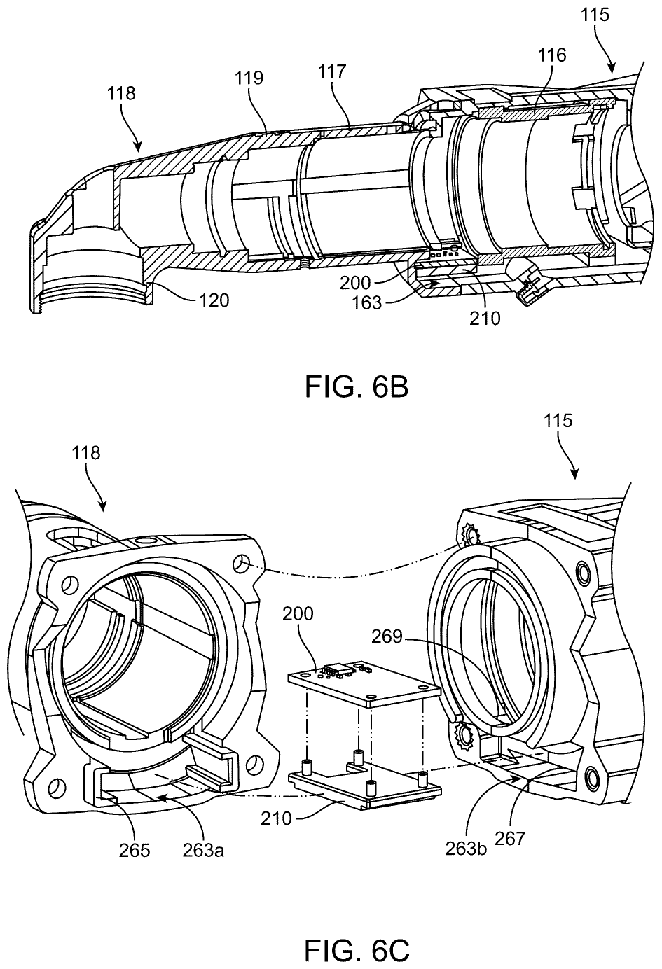

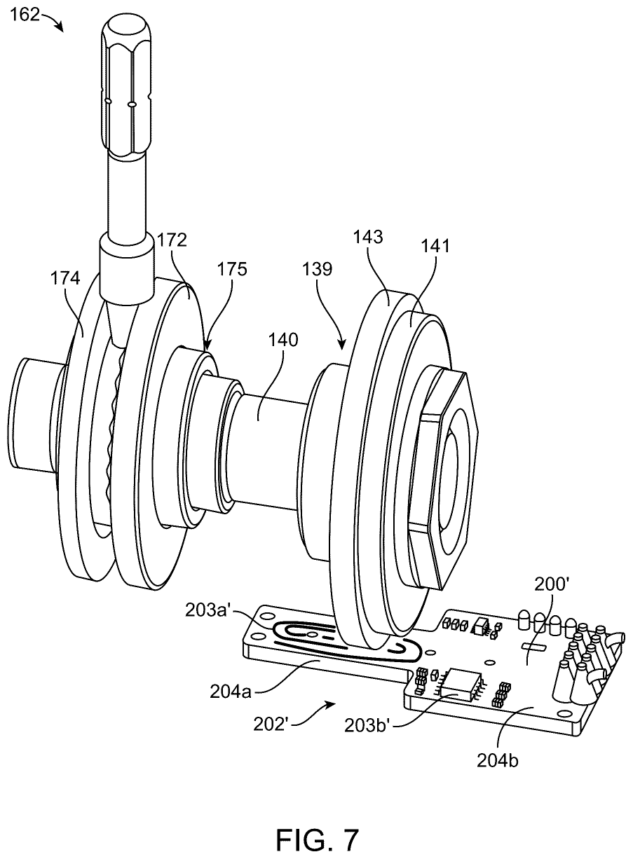

In an embodiment shown in FIG. 6A, the third PCBA 200 is substantially rectangular in shape and includes at least one clutch slip sensor 202, which, in the illustrated embodiment, is an inductive sensor including an induction coil 203a and an inductive position sensor chip 203b configured to receive signals from the induction coil 203a (i.e., voltage and/or current) and to thereby detect an axial position of the driven plate 143 during operation of the nutrunner 110. The illustrated driven plate 143 is made of a ferrous metal, such as steel. The induction coil 203a is energized with a voltage, which creates a magnetic field in the vicinity of the induction coil 203a. When the driven plate 143 moves axially during a clutching event, eddy currents form in the metal of the driven plate 143, causing the magnetic field produced by the induction coil 203a to collapse. This can be detected by the inductive position sensor chip 203b to determine the position of the driven plate 143 and to thereby determine that the clutch event has occurred.

With reference to FIGS. 6B-6C, the illustrated third PCBA 200 is supported by a carrier 210, which may include stakes extending through holes in the third PCBA 200. The carrier 210 and third PCBA 200 are sandwiched between the head 118 and the handle housing 115 such that the carrier 210 and third PCBA 200 are partially received within a first recess 263a formed in the head 118 and a second recess 263b formed in the handle housing 115. The illustrated first recess 263a includes a pair of C-shaped channels 265 that receive and support opposite sides of the carrier 210. A first opening 267 extends from the second recess 263b parallel to the first axis A, such that wires (not shown) may extend through the first opening 267 to connect the third PCBA 200 to the first PCBA 131, for example. A second opening 269 extends from the second recess 263b in a radial direction (perpendicular to the first axis A), and is aligned with the induction coil 203a to expose the induction coil 203a directly to the driven plate 143.

FIG. 7 illustrates an embodiment of a third PCBA 200′ similar to the third PCBA 200, which may be incorporated into the nutrunner 110 in place of the third PCBA 200. Accordingly, like structure will be identified by like reference numbers plus an apostrophe. Rather than being square in shape, the third PCBA 200′ may instead include a base portion 204a and an extension portion 204b. The third PCBA 200′ may include at least one clutch slip sensor 202′, which, in the illustrated embodiment, is an inductive sensor including an induction coil 203a′ and an inductive position sensor chip 203b′ configured to detect an axial position of the driven plate 143 during operation of the nutrunner 110. The induction coil 203a′ may be supported by the extension portion 204b and the sensor chip 203b′ may be supported by the base portion 204a.

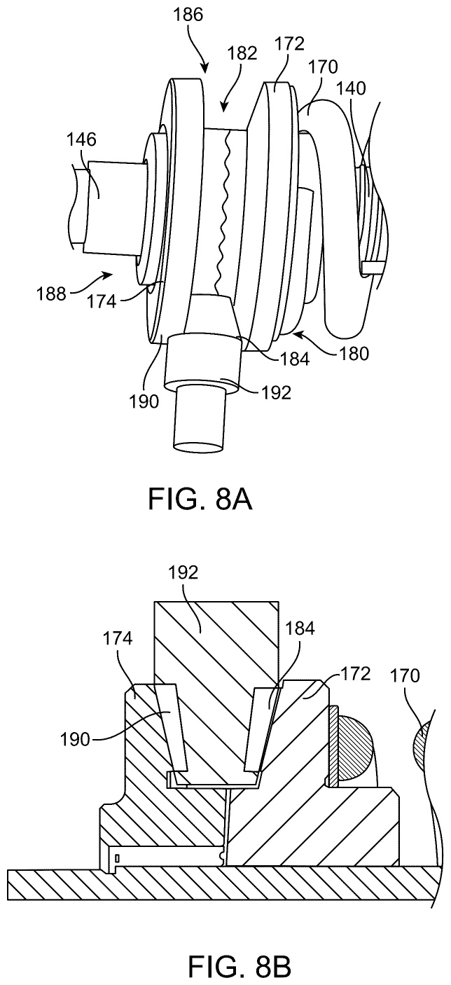

Referring to FIGS. 8A-8B, the first gear 172 is coupled for co-rotation with a second end 175 of the spindle 140 and the second gear 174 is coupled for co-rotation with the first bevel gear 146. The first gear 172 is slidable along the spindle 140 to adjust the pre-load on the spring 170. The first gear 172 includes a first side 180, a second side 182, and a plurality of first gear teeth 184 positioned on the second side 182. The second gear 174 includes a first side 186, a second side 188, and a plurality of second gear teeth 190 on the first side 186. The second gear 174 opposes the first gear 172. Accordingly, the first gear teeth 184 and the second gear teeth 190 create a wave pattern between the gears. The wave pattern corresponds to the adjuster 192 such that the adjuster 192 may be inserted between the first gear teeth 184 and the second gear teeth 190. The wave pattern is configured to make it difficult for the clutch settings to change during use (e.g., by vibrations, sudden force, etc.). Accordingly, in response to rotation of the adjuster 192, the first gear 172 moves axially along the spindle 140 (along axis A), thereby varying pre-load on the spring 170.

In operation, a user may operate the nutrunner 110 by grasping a handle portion of the housing 114 and sliding the actuator 134 to the “on position” to energize the motor 122. The motor 122 drives the motor output shaft 124, which provides a rotational input to the first transmission portion 138. The first transmission portion 138 drives the spindle 140, which provides a rotational input to the second transmission portion 142. The second transmission portion 142 drives the first bevel gear 146, which drives the second bevel gear 150 coupled to the output drive 126. Thus, the output drive 126 rotates (e.g., to drive a fastener). The first transmission portion 138 and the second transmission portion 142 each provide a speed reduction and torque increase from the motor output shaft 124 to the output drive 126. Thus, the output drive 126 is able to deliver a large amount of torque to the fastener. In some embodiments, the first bevel gear 146 and the second bevel gear 150 may be sized so as to provide a further speed reduction and torque increase.

The user may set a torque limit of the nutrunner 110 by inserting the exterior adjuster 192 through the aperture 166 such that the adjuster 192 interfaces with the first gear teeth 184 and the second gear teeth 190. The user may then rotate the adjuster 192 to adjust the torque limit of the clutch mechanism 162. More specifically, when the adjuster 192 is rotated, the first gear 172 moves axially along the spindle 140, thereby varying a pre-load on the spring 170. The spring 170 is configured to bias the driven plate 143 toward the drive plate 141. At torque levels below the set torque limit, the drive plate 141 transmits torque to the driven plate 143 and the spindle 140. When the torque exceeds the torque limit, the ball bearings 145 slip out of the recesses and torque transfer from the drive plate 141 to the driven plate 143 is interrupted.

During operation, the clutch slip sensor 202 detects the movement and location of the driven plate 143 as the nutrunner 110 experiences increasing levels of torque. Once the nutrunner 110 reaches the torque threshold, the driven plate 143 and the drive plate 141 slip. In response to the nutrunner 110 reaching the torque threshold, the driven plate 143 moves axially away from the drive plate 141, which is sensed by the clutch slip sensor 202. The clutch slip sensor 202 is in electrical communication with a controller (e.g., a programmable controller including a microprocessor, memory, and a suitable input/output interface for communicating with the clutch slip sensor 202), which may be provided on or distributed amongst any of the PCBAs 131, 144, 200. Based on feedback from the clutch slip sensor 202, the controller can determine that the clutch mechanism 162 has slipped. In response to determining that the clutch mechanism 162 has slipped, the controller may turn the motor 122 off, actively brake the motor 122 and/or perform another action, such as illuminating an indicator, or activating a sound, to give a user an indication that the clutch mechanism 162 has slipped.

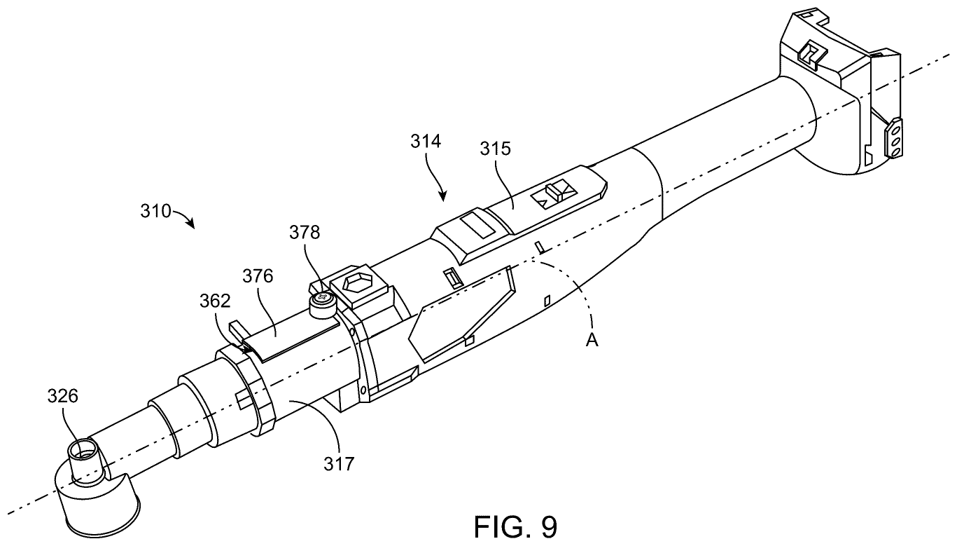

FIG. 9 illustrates a nutrunner 310 according to another embodiment of the disclosure. The nutrunner 310 of FIG. 9 is similar to the nutrunner 110 of FIGS. 1-8B; therefore, like structure will be identified by like reference numbers plus “200” and only the differences will be discussed hereafter. It should be understood that features of the nutrunner 310 may be incorporated into the nutrunner 110, and vise versa.

The nutrunner 310 includes a housing 314 and a clutch mechanism 362 disposed within the housing 314 to selectively limit torque transmission to an output drive 326 above a chosen torque threshold. To prevent tampering, or inadvertent adjustment of the nutrunner 310, a cover 376 is removably coupled to the clutch housing 317. The cover 376 is configured to enclose a slot (not shown) configured to allow an adjuster (see e.g., the adjuster 192 of the embodiment of FIGS. 1-8B) to be inserted into the nutrunner 310 to facilitate adjustment of the clutch mechanism 362 to different torque settings. The cover 376 is substantially rectangular in shape and extends along axis A. The cover 376 is secured to the clutch housing 317 via a fastener 378. In the present embodiment, the fastener 378 is a screw, but in alternate embodiments, the fastener 378 may be any of a plurality of different types of fasteners (e.g., nail, bolt, etc.). The cover 376 may be removed from the housing 314 by unscrewing the fastener 378.

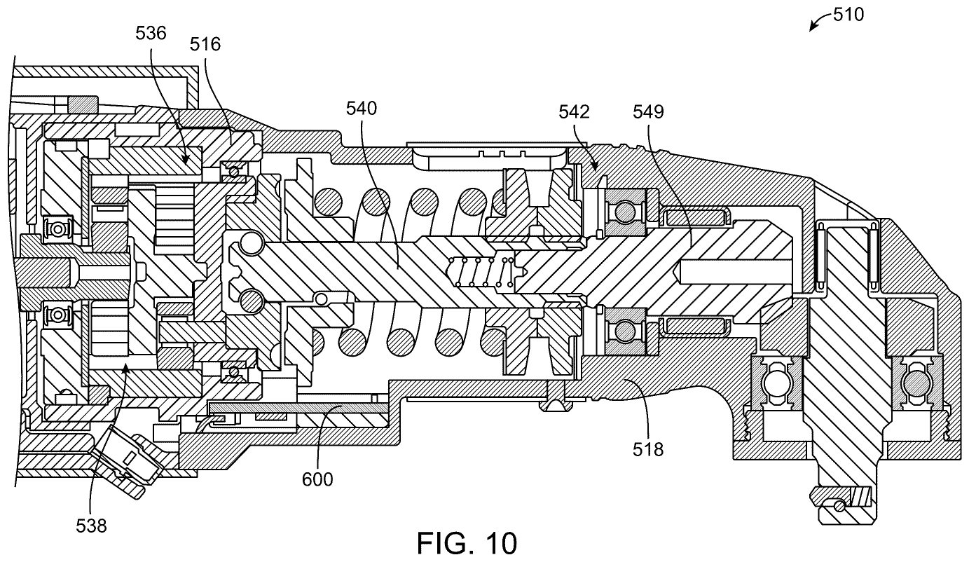

FIG. 10 illustrates a nutrunner 510 according to another embodiment of the disclosure. The nutrunner 510 of FIG. 10 is similar to the nutrunner 110 of FIGS. 1-8B; therefore, like structure will be identified by like reference numbers plus “400” and only the differences will be discussed hereafter. It should be understood that features of the nutrunner 510 may be incorporated into the nutrunners 110, 310, and vise versa.

In the illustrated embodiment, the nutrunner 510 includes a transmission 536 having only the first transmission portion 538 (that is, the second transmission portion 142 is omitted). The first transmission portion 538 is a two-stage planetary transmission in the illustrated embodiment. The output of the first transmission portion 538 drives the spindle 540, and the output of the clutch mechanism 542 is directly connected to the bevel gear shaft 549.

With continued reference to FIG. 10, the nutrunner 510 includes a gearcase 516 enclosing the transmission 536. The third PCBA 600 is sandwiched between the gearcase 516 and the head 518 of the nutrunner 510.

Although the present disclosure has been described in detail with reference to certain preferred embodiments, variations and modifications exist within the scope and spirit of one or more independent aspects of the disclosure as described.

Various features and advantages are set forth in the following claims.

What is claimed is:

1. A nutrunner comprising:
a housing;
a motor disposed within the housing and including an output shaft rotatable about a first axis;
a head extending from the housing, the head including an output drive that is rotatable about a second axis;
a transmission configured to transfer rotation from the output shaft to the output drive, the transmission including a drive plate that is rotatable about the first axis with respect to the housing;
a clutch mechanism including:
a driven plate coupled with the drive plate via a plurality of output bearings,
a spindle operatively coupled with the output shaft of the motor, the spindle having a first end coupled for co-rotation with the driven plate,
a first gear coupled for co-rotation with a second end of the spindle, and
a spring positioned around the spindle and between the first gear and the driven plate, the spring configured to bias the plurality of output bearings into engagement with the drive plate,
wherein when a torque applied to the driven plate is greater than or equal to a torque threshold, the output bearings slip and torque transfer from the drive plate to the driven plate is interrupted; and
a clutch slip sensor configured to detect an axial position of the driven plate,
wherein the clutch slip sensor includes an inductive sensor.

2. The nutrunner of claim 1, further comprising a slot in the housing, the slot configured to allow an adjuster to be inserted into the nutrunner to facilitate adjustment of the clutch mechanism to different torque settings.

3. The nutrunner of claim 1, further comprising a second gear coupled opposing the first gear, wherein the first gear includes a plurality of first gear teeth and the second gear includes a plurality of second gear teeth, wherein the first gear teeth and the second gear teeth create a wave pattern between the gears, the wave pattern corresponding to an adjuster such that the adjuster may be inserted between the first gear teeth and the second gear teeth.

4. The nutrunner of claim 3, wherein in response to rotation of the adjuster, the first gear moves axially along the spindle, thereby varying a pre-load on the spring.

5. The nutrunner of claim 1, further comprising a controller in communication with the clutch slip sensor, the controller configured to turn off the motor in response to feedback from the clutch slip sensor indicating that the clutch mechanism has slipped.

6. The nutrunner of claim 1, wherein the clutch slip sensor is disposed within a recess within the housing such that an internal portion of the housing supports the clutch slip sensor.

7. The nutrunner of claim 6, wherein the recess extends along a third axis parallel to the first axis.

8. The nutrunner of claim 1, wherein the housing includes a battery receptacle configured to receive a battery to provide power to the motor, and wherein the housing includes a grip portion extending between the battery receptacle and a motor housing portion of the housing in which the motor is supported.

9. The nutrunner of claim 8, further comprising a first printed circuit board assembly located in the housing between the motor and the battery receptacle, the first printed circuit board assembly including a plurality of switches for providing power to the motor.

10. The nutrunner of claim 9, further comprising a second printed circuit board assembly including a Hall effect sensor.

11. The nutrunner of claim 10, wherein the second printed circuit board assembly is located between the motor and the first printed circuit board assembly.

12. The nutrunner of claim 10, further comprising a third printed circuit board assembly including the clutch slip sensor.

13. The nutrunner of claim 12, wherein the clutch slip sensor includes an induction coil configured to provide signals to the inductive sensor.

14. The nutrunner of claim 12, wherein the third printed circuit board assembly is supported by a carrier, and wherein the carrier and the third printed circuit board assembly are sandwiched between the head and the housing.

15. The nutrunner of claim 13, wherein the third printed circuit board assembly is partially received within a first recess formed in the head and a second recess formed in the housing, wherein a first opening extends from the second recess parallel to the first axis, wherein a second opening extends from the second recess in a radial direction perpendicular to the first axis, and wherein the second opening is aligned with the induction coil to expose the induction coil directly to the driven plate.

16. A nutrunner comprising:
a housing including a battery receptacle configured to receive a battery, a motor housing portion, and a grip portion extending between the battery receptacle and the motor housing portion;
a motor supported within the motor housing portion, the motor including an output shaft rotatable about a first axis;
a head extending from the housing, the head including an output drive rotatable about a second axis;
a first printed circuit board assembly located in the housing between the motor and the battery receptacle, the first printed circuit board assembly including a plurality of switches for providing power to the motor;
a second printed circuit board assembly including a Hall effect sensor;
a clutch mechanism operatively coupled between the output shaft of the motor and the output drive such that the clutch mechanism is configured to slip to interrupt torque transmission from the output shaft to the output drive at a selected torque threshold; and
a third printed circuit board assembly including a clutch slip sensor configured to detect if the clutch mechanism slips.

17. The nutrunner of claim 16, wherein the second printed circuit board assembly is located between the motor and the first printed circuit board assembly.

18. The nutrunner of claim 17, wherein the third printed circuit board assembly is partially received within a first recess formed in the head, wherein the third printed circuit board assembly includes an induction coil, and wherein the induction coil is exposed directly to an axially-movable portion of the clutch mechanism.

19. The nutrunner of claim 17, wherein the second axis is perpendicular to the first axis.

20. A nutrunner comprising:
a housing including a battery receptacle configured to receive a battery, a motor housing portion, and a grip portion extending between the battery receptacle and the motor housing portion;
a motor supported within the motor housing portion, the motor including an output shaft rotatable about a first axis;
a head extending from the housing, the head including an output drive rotatable about a second axis perpendicular to the first axis;
a clutch mechanism operatively coupled between the output shaft of the motor and the output drive such that the clutch mechanism is configured to slip to interrupt torque transmission from the output shaft to the output drive at a selected torque threshold; and
a printed circuit board assembly including a clutch slip sensor configured to detect if the clutch mechanism slips,
wherein the printed circuit board assembly is partially received within a first recess formed in the head,
wherein the printed circuit board assembly includes an induction coil, and
wherein the induction coil is directly exposed to an axially-movable portion of the clutch mechanism.
